(19) United States
(12) Patent Application Publication
(10) Pub. No.: US 2018/0142718 A1
(43) Pub. Date: May 24, 2018

(54) CAGE AND CLAMP FOR CONNECTION

(71) Applicant: LF Centennial Limited., Tortola (VG)

(72) Inventor: Jia ZHU, Shanghai (CN)

(21) Appl. No.: 15/637,394

(22) Filed: Jun. 29, 2017

(30) Foreign Application Priority Data
Jun. 29, 2016 (CN) 201610497972.5
Jun. 29, 2016 (CN) 201620672650.5

(51) Int. Cl. F16B 17/00; F16B 5/00; F16B 12/02

(52) U.S. Cl. CPC F16B 17/008; A01K 1/03; F16B 12/02; F16B 5/0088

(57) ABSTRACT

A cage including a front plate, a back plate, a first side plate and a second side plate, which are arranged in the front, back, left and right side of the cage, and each of which has two columns; a plurality of clamps connecting and fixing the adjacent columns of the plates with each other; and a cover having four through holes through which the top ends of the columns of the front plate and the back plate or the top ends of the columns of the first side plate and the second side plate pass, wherein the clamps can be locked and unlocked.

### BACKGROUND

### Technical Field

The present disclosure relates to a cage, especially a cage that is easily assembled or disassembled without any tools.

### Description of the Related Art

As the life of people becomes better and better, pets have become more common, and have become an important member of the family, and expenditures on pets has risen.

A cages is often required for pets, indoors or outdoors; however, cages in the related art are large and difficult to assemble and disassemble, which wastes time.

### BRIEF SUMMARY

An object of the present disclosure is to provide a cage which is easily assembled or disassembled without any tools. Therefore, it saves time for assembly and improves the efficiency of the assembly. Since the cage is detachable, the space for the cage is saved and improves the efficiency of usage of the space of the room.

An aspect of present disclosure is a cage including

a plurality of side plates which are adjacent to each other and each of which has two columns, so as to form a close side surface of the cage;

a plurality of clamps connecting and fixing the adjacent columns of the adjacent side plates with each other; and

a cover having a plurality of through holes corresponding to the columns of the plurality of side plates, so as to make the top ends of the columns pass through the through holes, wherein
the clamps can be locked and unlocked.

Furthermore, the clamps includes

a first clamping portion, a second clamping portion, a locking portion and a spring, wherein

a first receiving portion and a second receiving portion are used for receiving the two columns, and

when locking the clamps, the locking portion compresses the spring, so as to make the second clamping portion move towards the first clamping portion to fasten the two columns, and

when unlocking the clamps, the locking portion makes the spring restore, so the second clamping portion is apart from the first clamping portion to release the two columns.

Furthermore, the locking portion includes handle portion and locking arc portion.

Furthermore, when locking the clamps, the handle portion is pushed to rotate, so the locking arc portion abuts the second clamping portion against the first clamping portion, the spring is compressed and the second clamping portion moves towards the first clamping portion, and

when unlocking the clamps, the handle portion is pushed to rotate conversely, so that the locking arc portion separates from the second clamping portion, the spring restores and the second clamping portion is apart from the first clamping portion.

The clamp further includes

a first connecting portion protruding from the center part of the first clamping portion and penetrating the hole in the center of the second clamping portion, so the second clamping portion can move along the first connecting portion, and

a second connecting portion extending from the sides of the first clamping portion towards the second clamping portion to the outer side of the locking arc portion, so the locking portion is fixed with the first clamping portion.

Furthermore, the adjacent columns are connected and fixed with two clamps.

In addition, the cage further includes a gate portion which is provided on one of the side plates.

Additionally, the columns are hollow.

Furthermore, the cage further includes caps which are inserted into the columns from above.

The cage further includes caps which are inserted into the columns from above.

Furthermore, the plurality of side plates include four side plates.

In addition, the cover has four through holes, making four columns of the opposed plates of the four plates inserted into the four through holes.

Another aspect of present disclosure is a clamp for connecting two objects, including:

a first clamping portion, a second clamping portion, a locking portion and a spring, wherein

a first receiving portion and a second receiving portion are used for receiving the two objects, and

when locking the clamps, the locking portion compresses the spring, so as to make the second clamping portion move towards the first clamping portion to fasten the two objects, and

when unlocking the clamps, the locking portion makes the spring restore, so the second clamping portion is apart from the first clamping portion to release the two objects.

Furthermore, the locking portion includes a handle portion and a locking arc portion.

In addition, when locking the clamps, the handle portion is pushed to rotate, so the locking arc portion abuts the second clamping portion against the first clamping portion, the spring is compressed and the second clamping portion moves towards the first clamping portion, and

when unlocking the clamps, the handle portion is pushed to rotate conversely, so the locking arc portion separates from the second clamping portion, the spring restores and the second clamping portion is apart from the first clamping portion.

The clamp further includes

a first connecting portion protruding from the center part of the first clamping portion and penetrating the hole in the center of the second clamping portion, so the second clamping portion can move along the first connecting portion, and

a second connecting portion extending from the sides of the first clamping portion towards the second clamping portion to the outer side of the locking arc portion, so the locking portion is fixed with the first clamping portion.

According to above aspects, it saves time for assembly and improves the efficiency of the assembly. Since the cage is detachable, the space for the cage is saved and improves the efficiency of usage of the space of the room.

### BRIEF DESCRIPTION OF THE SEVERAL VIEWS OF THE DRAWINGS

FIG. 1 is a perspective view illustrating a schematic structure, which is a diagram illustrating a cage, according to an exemplary embodiment.

FIG. 2 is a perspective view illustrating a schematic structure, which is a diagram illustrating the cage shown in FIG. 1 without a cover, according to an exemplary embodiment.

FIG. 3 is an enlarged view of the clamp of the part of the cage in the circle shown in FIG. 2 in a released state, according to an exemplary embodiment.

FIG. 4 is an enlarged view of the clamp of the part of the cage in the circle shown in FIG. 2 in a locked state, according to an exemplary embodiment.

FIG. 5 is an enlarged view of the clamp, according to an exemplary embodiment.

FIG. 6 is an enlarged view of the clamp seen from the view point different from FIG. 5, according to an exemplary embodiment.

FIG. 7 is an enlarged view of the clamp seen from the view point different from FIGS. 5 and 6, according to an exemplary embodiment.

FIG. 8 is an enlarged view of a part of the cage when viewed from above, according to an exemplary embodiment.

FIG. 9 is a view illustrating the cover of the cage, according to an exemplary embodiment.

FIG. 10 is a view illustrating the connection between the cap and the column, according to an exemplary embodiment.

### DETAILED DESCRIPTION

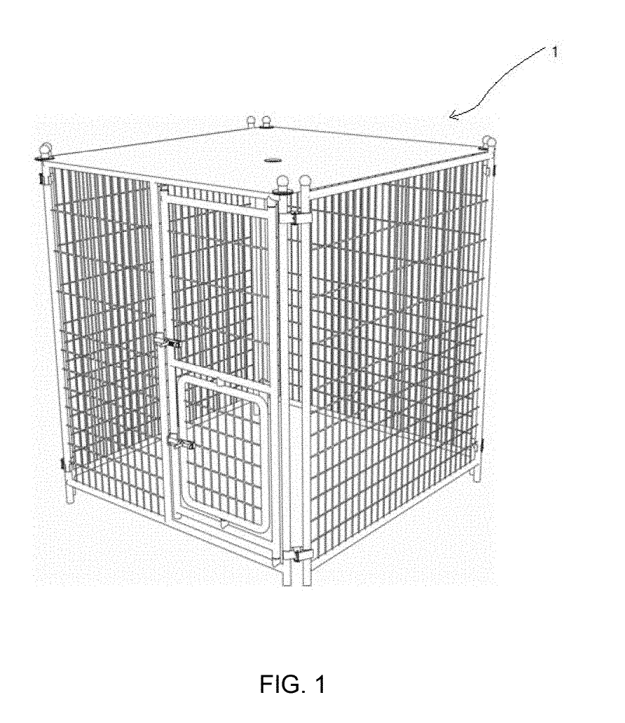

The construction of a cage according to an exemplary embodiment will be described in detail with the reference to FIGS. 1-7.

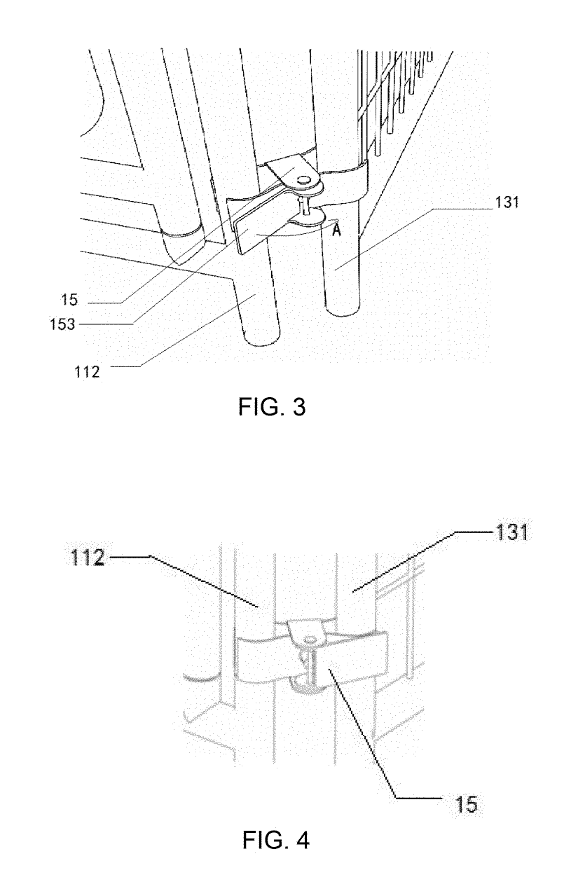

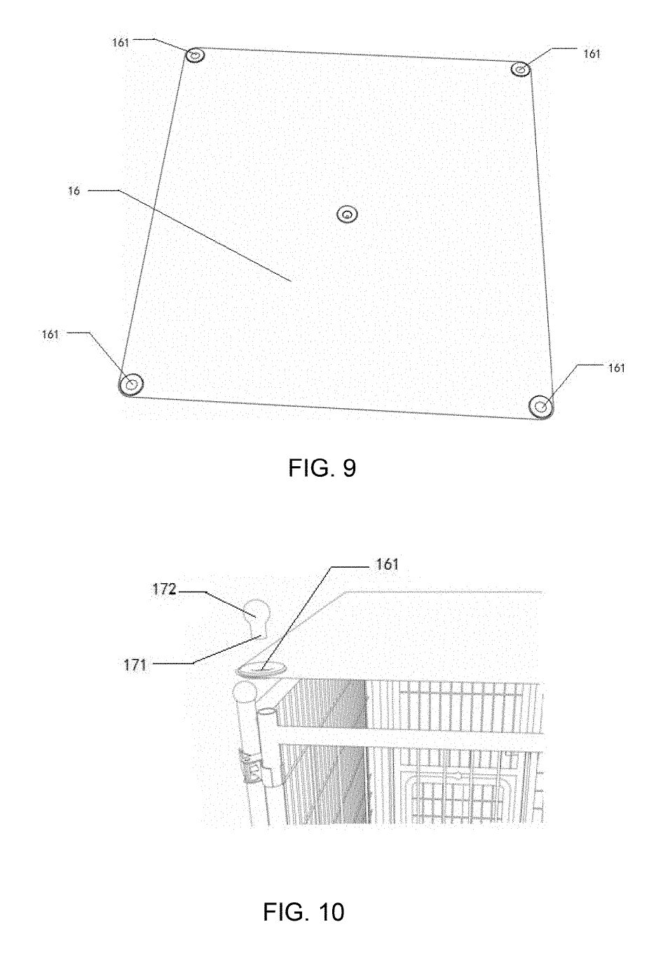

As shown in FIGS. 1-10, FIGS. 1 and 2 show the overall construction of the cage according to the disclosure. FIGS. 3-7 show the clamp of the cage and the connection of the clamp in detail. FIGS. 8-10 show the upper part of the cage.

The cage 1, according to the exemplary embodiment, includes a front plate 11, a back plate 12, a first side plate 13, a second plate 14, a plurality of clamps 15 and a cover 16 and, preferably, the cage further includes a plurality of caps 17. The construction of each portion will be described in detail below.

As shown in FIG. 2, the front plate 11 has a first column 111 and a second column 112 on the left and right sides, a large gate portion 113 and a small gate portion 114. The large gate portion 113 is locked with the front plate 11 through a first locking portion (not shown in drawings), and the small gate portion 114 is locked with the large gate portion 113 through a similar second locking portion (not shown in drawings). When big pets come in or go out of the cage, the large gate portion 113 is opened with respect to the front plate 11. When small pets come in or go out of the cage, the small gate portion 114 is opened with respect to the locked large gate portion 113. The first column 111 and the second column 112 are connected with the upper and lower beams so as to form a frame structure. Furthermore, inside the frame structure, the frame structure becomes more stable by vertical and horizontal linear portions, such as steel wires.

The back plate 12, the first side plate 13 and the second plate 14 have the same structure as the front cage 11 without the gate portion. The back plate 12, the first side plate 13 and the second plate 14 have first columns 121 (not shown), 131, 141 and second columns 122, 132, 142 (not shown) on the left and right side, respectively. The first columns 121, 131, 141 are connected with the corresponding second columns 122, 132, 142 through the same structure with that of the front plate 11.

All of the columns described above are hollow columns and have the same height, outer and inner diameter, and the like.

The present disclosure is not limited to the frame structure above, and it can be a plate shape connecting the first column and the second column. In addition, the number of the linear portions is not limited either. Preferably, the front plate 11, the back plate 12, the first side plate 13 and the second plate 14 have the same disposure of the linear portion (with the exception of the door portion of the front plate 11).

The clamps 15 are connecting members, connecting the adjacent columns of adjacent plates of the front plate 11, the back plate 12, the first side plate 13 and the second plate 14. There are two clamps between the adjacent two columns at the upper part and the lower part thereof. As shown in FIG. 2, for example, there are two clamps 15 between the adjacent two columns 112 and 131 of the front plate 11 and the first side plate 13.

The construction of the clamps 15 will be described in detail below with the reference to FIGS. 3-7.

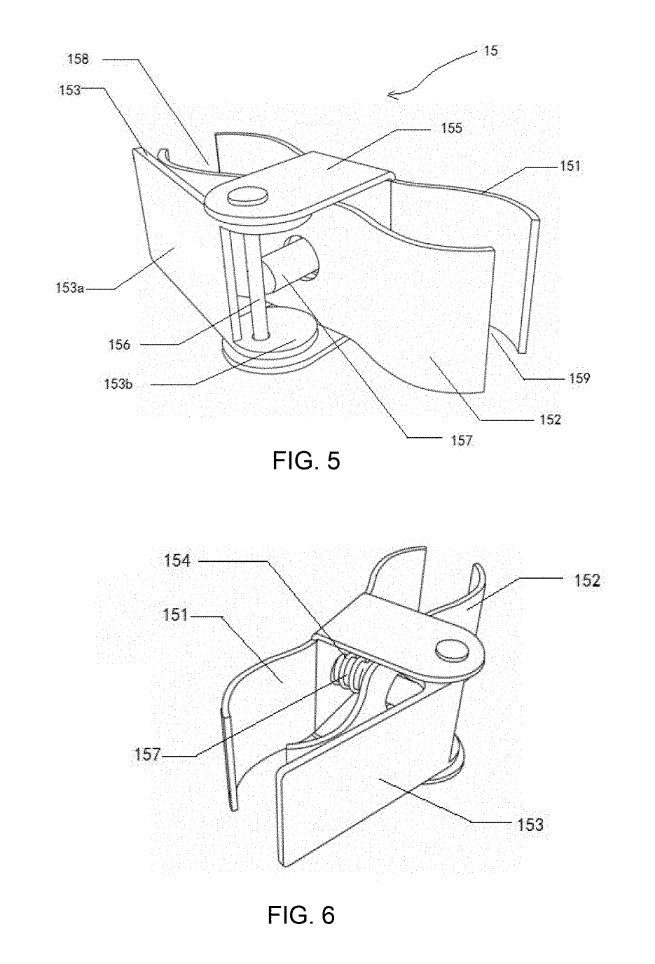

As shown in FIG. 5, the clamp 15 includes a first clamping portion 151, a second clamping portion 152, a locking portion 153, a spring 154, a second connecting portion 155, a bolt 156 and a first connecting portion 157. The above portions will be described in detail below.

The first clamping portion 151 and the second clamping portion 152 are formed into double-peaked plate shapes and opposed to each other, so the two peaks are opposite each other. Therefore, each column 112, 131 of the front plate 11 and the first side plate 13 has a first column receiving portion 158 and a second column receiving portion 159 to be received therein.

The first connecting portion 157 is a columnar projection formed in the central part of the surface of the first clamping portion 151 which faces the second clamping portion 152, and the first connecting portion 157 penetrate the hole (not shown) formed in the center of the second clamping portion 152, so the second clamping portion 152 is movable along the first connecting portion 157 towards or away from the first clamping portion 151.

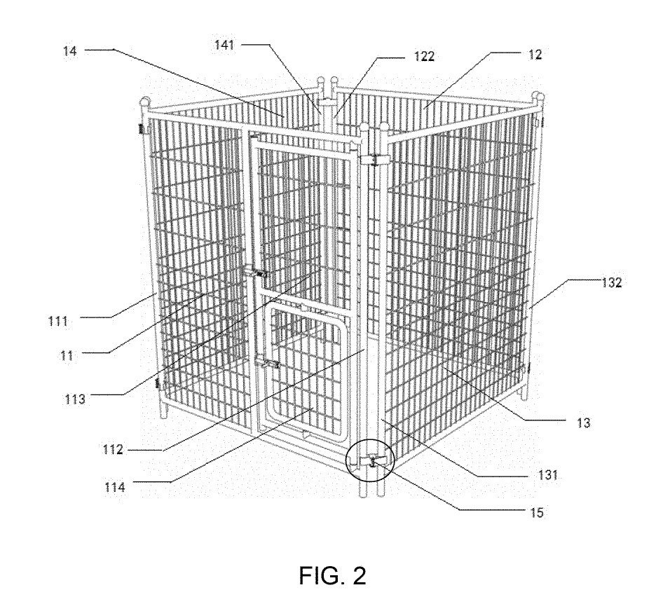

The outer circumstance surface of a part of the first connecting portion 157 between the first clamping portion 151 and the second clamping portion 152 is surrounded by the spring 154. As is shown in FIG. 6, the spring 154 is supported between the first clamping portion 151 and the second clamping portion 152, so as to keep the distance therebetween.

The locking portion 153 includes a handle portion 153a and a locking arc portion 153b. The handle portion 153a is formed into a plate shape so the locking portion 153 is rotatable when external force is applied thereto. The locking arc portion 153b is continuous with the handle portion 153a and erects from the base of the handle portion 153a to form into an eccentric circular shaped about the holes (not shown) formed therein, so the distance between the center of the hole and the edge of the locking arc portion 153b is changeable.

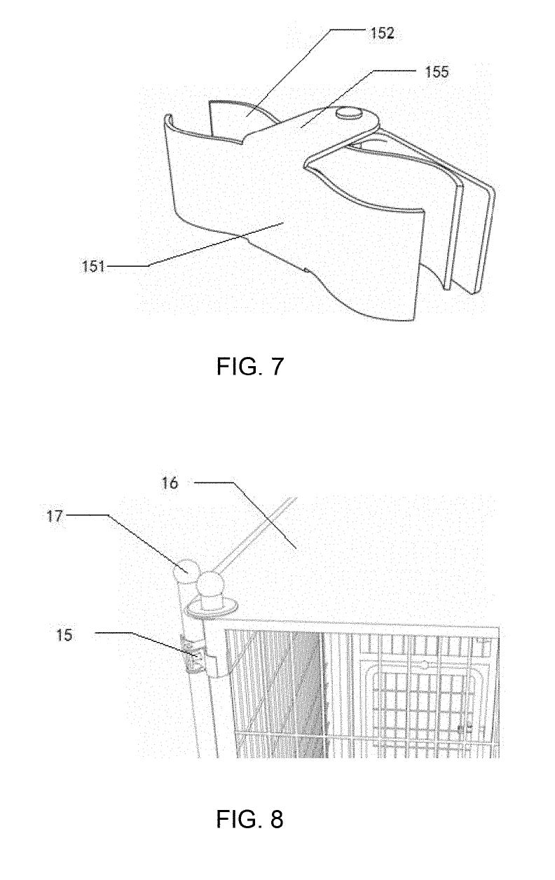

As is shown in FIGS. 5 and 7, the second connecting portion 155 is formed integrally with the first clamping portion 151 so as to rise from both sides of the central portion of the first clamping portion 151 in a direction towards the second clamping portion 152. The leading portion of the second connecting portion 155 extends to the external surface of locking arc portion 153b, so the hole formed at the leading portion of second connecting portion 155 communicates with the hole formed in the locking arc portion 153b.

The bolt 156 penetrates through the two holes of the locking arc portion 153b and the two holes formed in the upright sides of the second connecting portion 155, so the locking arc portion 153b is located inside the second connecting portion 155. Therefore, the locking portion 153 is connected with the first clamping portion 151 and is fixed relatively, and the locking portion 153 is rotatable around the bolt 156 penetrating though the holes formed therein.

The locking principle will be described below in detail with reference to FIGS. 3-5.

As is shown in FIG. 3, when the handle portion 153a of the locking portion 153 is pushed along the direction of arrow A until it reaches to the position shown in FIG. 4, the locking portion 153 rotates about the bolt 156, and the locking arc portion 153b gradually contacts the second clamping portion 152 and, then, abuts against it as the locking portion 153 rotates. Therefore, the second clamping portion 152 is pushed towards the first clamping portion 151 by the locking arc portion 153b along the first connecting portion 157. As the locking portion 153 rotates along the arrow A, the spring 154 is compressed, and the distance between the second clamping portion 152 and the first clamping portion 151 becomes smaller, so as to fasten the two columns 112, 131 of the front plate 11 and the first side plate 13 therein. The fastening and locking of the clamps 15 are completed when the handle portion 153a moves to the state shown in FIG. 4.

When the handle portion 153a of the locking portion 153 is pushed along the direction opposite to arrow A to make the locking portion 153 rotate about the bolt 156, the spring 154 restores and the locking arc portion 153b gradually separates from the second clamping portion 152 as the locking portion 153 rotates. Therefore, the second clamping portion 152 moves away from the first clamping portion 151 by the locking arc portion 153b along the first connecting portion 157. As the locking portion 153 rotates along the direction opposite to arrow A, the distance between the second clamping portion 152 and the first clamping portion 151 becomes larger, so as to release and unlock the two columns 112, 131 of the front plate 11 and the first side plate 13 therein. The releasing and unlocking of the clamps 15 are completed when the handle portion 153a moves to the state shown in FIG. 3.

The construction of the cover 16 and the caps 17 of the cage 1 will be described in detail below with the reference to FIGS. 8-10.

As is shown in FIG. 8, the cover 16 is a rectangular plate, and there are four through holes 161 formed at the four corners, respectively. The locations of the four through holes 161 correspond to the four columns 111, 112, 121, 122 of the front plate 11 and the back plate 12, respectively, and the diameter of the through holes 161 is larger than the outer diameter of the columns. As is shown in FIG. 1, the top portion of the four columns 111, 112, 121, 122 of the front plate 11 and the back plate 12 is inserted into the four through holes 161 of the cover 16, respectively, and the cover 16 is located above the upper beams, so that the cover 16 is located above the front plate 11 and the back plate 12 and covers the top side of the cage 1.

It is also possible to insert the top portion of the four columns 131, 132, 141, 142 of the first side plate 13 and the second side plate 14 into the four through holes 161 of the cover 16, respectively, so the cover 16 is located above the first side plate 13 and the second side plate 14 and covers the top side of the cage 1.

There are only four through holes formed in the cover 16, to reduce cost and for ease of production. The number of the through holes can also be eight, instead of four, so that the top portion of all the columns is inserted into the eight through holes.

The caps 17 are provided in order to prevent the top portion of the columns inserted from impacting surrounding objects. The caps 17 each have a cylindrical base 171 which has an outer diameter smaller than the inner diameter of the columns; and a globular portion 172 continuous with the cylindrical base 171.

The assembly procedure of the cage 1 according to the exemplary embodiment will be described below.

First, the front plate 11, the back plate 12, the first side plate 13 and the second plate 14 are arranged at front, back, right, and left directions. Subsequently, using two clamps 15 each at the upper portion and the lower portion between two adjacent columns, i.e., eight clamps 15 in total, so as to insert the columns into the column receiving portions, connecting the second column 112 of the front plate 11 to the first column 131 of the first side plate 13, the second column 132 of the first side plate 13 to the first column 121 of the back plate 12, the second column 122 of the back plate 12 to the first column 141 of the second side plate 14, and the second column 142 of the second side plate 14 to the first column 111 of the front plate 11.

Then, the clamps 15 fasten and lock the above columns through the rotation of the handle portion 153a, so a closed cage frame is formed on the front, back, left and right sides.

Then, the cover 16 is placed above the four plates above, so the top portion of the four columns 111, 112, 121, 122 of the front plate 11 and the back plate 12 are inserted into the four through holes 161, respectively. Therefore, the cover 16 is located above the upper beams, and the cover 16 is located above the front plate 11 and the back plate 12 to cover the top side of the cage 1.

At last, the caps 17 are inserted into the inside of all the hollow columns 111, 112, 121, 122, 131, 132, 141 and 142, respectively.

The embodiments are only examples of the present disclosure, and the disclosure is not limited to these embodiments. For example, the number of the clamps 15 disposed between the adjacent two columns is not limited to two, but can be three or more. Furthermore, the present application is not limited to four side plates, but can have a plurality of side plates of more than three plates.

For example, the closed side surfaces of the cage are composed of five side plates that form a round. And the cover has a pentagon shape and has ten through holes corresponding to all the columns of the five side plates. The number of the through holes of the cover is not limited and the connection method between the cover and the side plates is not limited, as long as the cover covers the upper open of the side plates.

Furthermore, the gate portion is not limited to the large gate portion 113 and the small gate portion 114, as long as there is a gate that allow the pets to pass through. And the opening direction and the disposure of the gate are not limited either.

Furthermore, the cage in the present disclosure may have wheels at the bottom to be freely movable.

The cage as described as above, is easy to assemble or disassemble without any tools. Therefore, it saves time for assembly and improves the efficiency of the assembly. Since the cage is detachable, the space for the cage is saved and improves the efficiency of usage of the space of the room.

It will be clear that the present disclosure may be embodied with numerous modifications within a scope that does not depart from the spirit of the present disclosure.

1. A cage, comprising:
a plurality of side plates adjacent to each other and each of which has two columns so as to form a close side surface of the cage;
a plurality of clamps connecting and fixing the adjacent columns of the adjacent side plates with each other; and
a cover having a plurality of through holes corresponding to the columns of the plurality of side plates, so as to make the top ends of the columns pass through the through holes, wherein
the clamps can be locked and unlocked.

2. The cage according to claim 1, wherein the clamps comprise:
a first clamping portion, a second clamping portion, a locking portion and a spring, a first receiving portion and a second receiving portion, wherein
the first receiving portion and the second receiving portion are used for receiving the two columns, and
when locking one of the plurality of clamps, the locking portion compresses the spring, so as to make the second clamping portion move towards the first clamping portion to fasten the two columns, and
when unlocking the one of the plurality of clamps, the locking portion makes the spring restore, so the second clamping portion is apart from the first clamping portion to release the two columns.

3. The cage according to claim 2, wherein the locking portion includes a handle portion and a locking arc portion.

4. The cage according to claim 3, wherein
when locking the one of the plurality of clamps, the handle portion is pushed to rotate, so the locking arc portion abuts the second clamping portion against the first clamping portion, the spring is compressed and the second clamping portion moves towards the first clamping portion, and
when unlocking the one of the plurality of clamps, the handle portion is pushed to rotate conversely, so the locking arc portion separates from the second clamping portion, the spring restores and the second clamping portion is apart from the first clamping portion.

5. The cage according to claim 2, wherein the one of the plurality of clamps further comprises:
a first connecting portion protruding from a center part of the first clamping portion and penetrating a hole in a center of the second clamping portion, so the second clamping portion can move along the first connecting portion, and
a second connecting portion extending from sides of the first clamping portion towards the second clamping portion to an outer side of the locking arc portion, so the locking portion is fixed with the first clamping portion.

6. The cage according to claim 1, wherein the adjacent columns are connected and fixed with two clamps.

7. The cage according to claim 1, further comprising a gate portion which is provided on one of the side plates.

8. The cage according to claim 1, wherein the columns are hollow.

9. The cage according to claim 8, wherein the cage further includes caps which are inserted into the columns from above.

10. The cage according to claim 1, wherein the plurality of side plates include four side plates.

11. The cage according to claim 10, wherein the cover has four through holes.

12. A clamp for connecting two objects, comprising:
a first clamping portion, a second clamping portion, a locking portion and a spring, a first receiving portion and a second receiving portion, wherein
the first receiving portion and the second receiving portion are used for receiving the two objects, and
when locking the clamp, the locking portion compresses the spring, so as to make the second clamping portion move towards the first clamping portion to fasten the two objects, and
when unlocking the clamp, the locking portion makes the spring restore, so the second clamping portion is apart from the first clamping portion to release the two objects.

13. The clamp according to claim 12, wherein the locking portion includes a handle portion and a locking arc portion.

14. The clamp according to claim 13, wherein
when locking the clamp, the handle portion is pushed to rotate, so the locking arc portion abuts the second clamping portion against the first clamping portion, the spring is compressed and the second clamping portion moves towards the first clamping portion, and
when unlocking the clamp, the handle portion is pushed to rotate conversely, so the locking arc portion separates from the second clamping portion, the spring restores and the second clamping portion is apart from the first clamping portion.

15. The clamp according to claim 12, comprising:
a first connecting portion protruding from a center part of the first clamping portion and penetrating a hole in a center of the second clamping portion, so the second clamping portion can move along the first connecting portion, and
a second connecting portion extending from sides of the first clamping portion towards the second clamping portion to an outer side of the locking arc portion, so the locking portion is fixed with the first clamping portion.
